(19) United States
(12) Patent Application Publication
(10) Pub. No.: US 2023/0069480 A1
(43) Pub. Date: Mar. 2, 2023

(54) UAV POSITIONING SYSTEM AND METHOD FOR CONTROLLING THE POSITION OF AN UAV

(71) Applicant: Tinamu Labs AG, Zurich (CH)

(72) Inventors: Tobias NÄGELI, Zurich (CH); Martin RUTSCHMANN, Elsau (CH); Samuel OBERHOLZER, Zurich (CH)

(21) Appl. No.: 17/797,041

(22) PCT Filed: Jan. 29, 2021
(86) PCT No.: PCT/IB2021/050719

§ 371 Date: Aug. 2, 2022

(30) Foreign Application Priority Data
Feb. 13, 2020 (CH) 00158/20

(51) Int. Cl. G05D 1/10; B64C 39/02; G06T 7/73; G06T 7/277

(52) U.S. Cl. CPC G05D 1/101; B64C 39/024; G06T 7/74; G06T 7/277; B64C 2201/145; B64C 2201/146; G06T 2207/10032; G06T 2207/30204; G06T 2207/30244

(57) ABSTRACT

The invention relates to a method of controlling an UAV along a predefined path and to an UAV positioning system, the system comprising: —at least one flexible positioning stripe (30) comprising markers (32) distributed along said positioning stripe (30) to form different configurations of patterns, each of said configurations of patterns defining a reference position along the flexible positioning stripe (30), wherein said positioning stripe (30) may be positioned along a predefined path, —an UAV (12), —a position estimation module (14) mounted on the UAV and comprising a camera (16) configured to capture images in real-time of said configuration of patterns along the flexible positioning stripe (30)—a control unit (20) configured to control the velocity of the UAV. The position estimation module (14) is configured to position the UAV (12) above, below or next to the positioning stripe (30) and along aid positioning stripe (30) based on successive configurations of patterns captured by the camera (16) of the position estimation module (14). The at least one flexible positioning stripe (30) comprises a controller (34) configured to dynamically control active markers (32) based on the velocity of the UAV (12) and the positions of said active markers (32) along the position stripe (30) in order to generate said successive configuration of patterns.

### FIELD OF THE INVENTION

The present invention relates to Unmanned Aerial Vehicle (UAV) positioning system for repetitive UAV flights along a predefined flight path as well as a vehicle positioning kit. The UAV position system and the vehicle positioning kit may be used in particular for filming sport events particularly long-range sports such as skiing or motorsports as well as in movie productions. The UAV position system and vehicle positioning kit may also be used for surveillance or inspection of an environment where access to GPS is limited or unavailable. The invention also relates to a method for controlling the position of an UAV.

### DESCRIPTION OF RELATED ART

There are currently several tracking technologies available in the UAV industry among which the global positioning system (GPS) satellite-based system which uses a GPS receiver to receive location from the GPS satellites to determine the location of the UAV within a navigation environment. The GPS receiver periodically receives information from broadcasting GPS satellites and uses that information to triangulate the position of the UAV. However, in certain environments, GPS systems suffer from limited availability of the GPS signals and fail to work as well as may be desired.

Different positioning systems for UAV have been proposed to overcome the problem of sporadic loss of a GPS signal.

US2012/0197519 for example discloses a navigation system and method for determining a location of a navigator in a navigation environment using coded markers. The navigation system may include a camera apparatus configured to obtain an image of a scene containing images of at least one coded marker in a navigation environment, video analytics configured to read the at least one coded marker, and a processor coupled to the video analytics and configured to determine a position fix of a navigator based on a known location of the at least one coded marker.

In US2019/235531, systems and methods are provided for positioning an unmanned aerial vehicle-UAV in an environment. The UAV may be able to identify visual markers and patterns in the environment. The visual markers can be analyzed with visual sensors to determine the position of the UAV in the environment. The locating marker may be dynamic (e.g. changeable. Dynamic markers as disclosed in WO2016/065623 are in the form of a screen display (e.g. liquid crystals display (LCD), touch screen, LED screen, OLED screen, or plasma screen display) or projected on to a surface from a projector installed in the environment.

US2020/005656 describes a system for determining a location independent of a global navigation satellite system (GNSS) signal in autonomous vehicles, especially in UAVs. The system may comprise rigid strips comprising visual markers to guide the UAVs along a predefined path.

The above described markers have the inconvenient to be costly, difficult to set-up and/or to be changed to another set-up configuration.

### BRIEF SUMMARY OF THE INVENTION

An aim of the present invention is therefore to provide an Unmanned Aerial Vehicle (UAV) positioning system as well as a vehicle positioning kit that are easy and cost effective to set-up.

Another aim of the present invention is to provide an UAV positioning system, whereby a predetermined path of the position system can be easily modified according to the environment constraints.

A further aim of the present invention is to provide a method of controlling an UAV along a predefined path.

These aims are achieved, according to an aspect of the invention, by an Unmanned Aerial Vehicle (UAV) positioning system, comprising:
at least one positioning stripe comprising markers distributed along said positioning stripe to form different configurations of patterns, each of said configurations of patterns defining a reference position along the flexible positioning stripe, wherein said positioning stripe may be positioned along a predefined path,
an UAV
a position estimation module mounted on the UAV and comprising a camera configured to capture images in real-time of said configuration of patterns along the flexible positioning stripe, and
a control unit configured to control the velocity of the UAV.

The position estimation module is configured to position the UAV above, below or next to the positioning stripe and therealong based on successive configurations of patterns captured by the camera of the position estimation module. The at least one positioning stripe comprises a controller configured to dynamically control active markers based on the velocity of the UAV and the positions of the active markers along the position stripe in order to generate the successive configurations of patterns.

In an embodiment, the UAV or the position estimation module further comprises an Inertial Measurement Unit (IMU).

In an embodiment, the active markers are arranged along the at least one positioning stripe at constant intervals.

In an embodiment, the markers are Light Emitted Diodes (LEDs).

In an embodiment, the LEDs are Near-IR LEDs, preferably in the spectral range from 920 nm to 960 nm, and most preferably around 940 nm.

In an embodiment, the at least one positioning stripe is made of several removably coupled segments in order to provide a length-adjustable positioning stripe.

In an embodiment, the at least one positioning stripe is flexible preferably made of a PVC base-material.

In an embodiment, the UAV positioning system comprises two flexible positioning stripes adapted to be arranged in parallel along said predefined path.

Another aspect of the invention relates to a method of controlling an Unmanned Aerial Vehicle (UAV) along a predefined path using a dynamically controlled positioning stripe, a position estimation module mounted the UAV and a control unit configured to control the velocity of the UAV. Active markers are distributed along the positioning stripe. Each marker is configured to be switched between an ON state and an OFF state to form different configurations of patterns. The position estimation module comprises a camera configured to captures images of portions of the positioning stripe.

The method comprises the steps of:
computing the ground truth position pᵢ of the active markers in terms of world coordinates [xᵢ^{W}, yᵢ^{w}, zᵢ^{w}] in order to obtain a 3D representation of the markers;
capturing successive images of portions of the positioning stripe by the camera of the position estimation module while the UAV is moving along the positioning stripe to obtain successive image planes comprising each a distinctive pattern formed by a set of detected active markers,
measuring the 2D coordinates zᵢ of each detected active marker in each image plane;
assigning a unique label to each detected marker in each image plane as a function of its position relative to the other detected markers in said image plane,
matching the 2D coordinates zᵢ of each image plane to said 3D representation of the markers in order to track the camera pose over subsequent interval of times, and
controlling the orientation of UAV as a function of the camera pose.

In an embodiment, the UAV is positioned above the positioning stripe at a certain height which is either controlled manually by the remote-control unit, or constant over and along the entire length of the positioning stripe or as a function of the x-y position of successive portions of the positioning stripe.

In an embodiment, the pose of the camera is fine-tuned based on information about yaw, pitch and roll angles sent to the UAV by the control unit.

In an embodiment, the UAV or the position estimation module comprises an Inertial Measurement Unit (IMU) (18). The pose of the camera is fine-tuned based on the measurements of the IMU.

In an embodiment, only the active markers of the positioning stripe in the vicinity of the UAV are controlled based on the image planes.

In an embodiment, the UAV or the position estimation module comprises a GPS sensor. A unique binary pattern is located near an end portion of the positioning stripe to send information to the UAV in order to switch from the positioning stripe to a GPS navigation system.

In an embodiment, the step of computing the ground truth position pᵢ of the markers in terms of world coordinates [xᵢ^{W}, yᵢ^{w}, zᵢ^{w}] is achieved from a structure from motion (SFM) algorithm.

In an embodiment, the ego-motion of the camera is estimated using a non-linear estimator, for example an extended Kalman filter, in order to add temporal dependency between successive images captured by the camera and camera poses (C₁, C₂, C₃).

Another aspect of the invention relates to a vehicle positioning kit, for example an Unmanned Aerial Vehicle (UAV), comprising:
at least one positioning stripe comprising markers distributed along the positioning stripe to form different configurations of patterns, each of said configurations of patterns defining a reference position along the positioning stripe, wherein the positioning stripe may be positioned along a predefined path, and
a position estimation module adapted to be mounted on an vehicle and comprising a camera configured to capture images in real-time of the configuration of patterns along the flexible positioning stripe.

The position estimation module is configured to position the vehicle above, below or next to the positioning stripe and therealong based on successive configurations of patterns captured by the camera of the position estimation module.

In an embodiment, the vehicle positioning kit further comprises a remote-control unit configured to control the velocity of the vehicle.

### BRIEF DESCRIPTION OF THE DRAWINGS

The invention will be better understood with the aid of the description of several embodiments given by way of examples and illustrated by the figures, in which:

FIG. 1 shows a schematic view of the UAV flying along a flight path corresponding to the path profile of the dynamically controlled positioning stripe;

FIG. 2 shows a data flowchart for controlling the UAV along the flight path;

FIG. 3 shows a portion of the flexible positioning stripe with LEDs selectively turn-on to form a binary pattern;

FIG. 4 shows the image captured by the position estimation module of the UAV with detected binary pattern.

FIG. 5 shows labeled points based on the image of FIG. 4;

FIG. 6 shows motion of the camera pose of the position estimation module with temporal dependency;

FIG. 7 shows a schematic view of a single dynamically controlled positioning stripe and resulting image from the camera of the position estimation module according to a preferred embodiment;

FIG. 8 shows a schematic view of two parallel dynamically controlled positioning stripes and resulting image from the camera of the position estimation module according to another embodiment;

FIG. 9 shows a perspective n-point (PnP) view to recover the camera position and orientation of the camera coordinate system of the position estimation module from the dynamically controlled positioning stripe, and

FIG. 10 shows a schematic view of the dynamically controlled positioning stripe and the UAV, wherein only LED's in the vicinity of the UAV are turned on.

### DETAILED DESCRIPTION OF SEVERAL EMBODIMENTS OF THE INVENTION

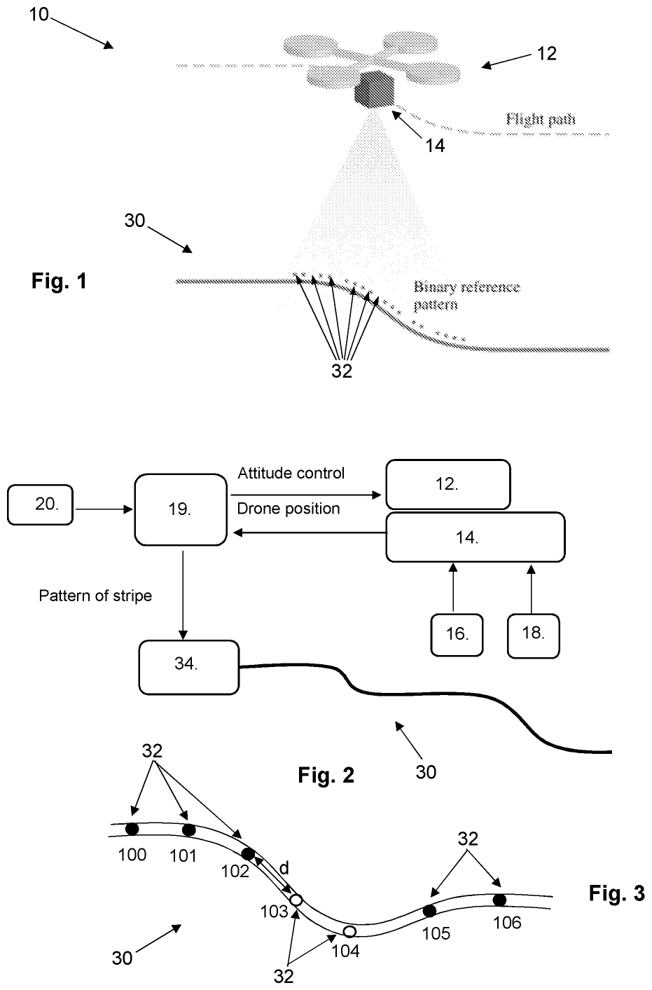

FIG. 1 shows an Unmanned Aerial Vehicle (UAV) positioning system 10 according to an embodiment of the invention. The UAV positioning system 10 comprises a dynamically controlled flexible positioning stripe 30 and a position estimation module 14 mounted on an UAV 12 flying above the flexible positioning stripe. The flexible positioning stripe 30 comprises active markers 32 distributed therealong and a stripe controller 34 (FIG. 2) configured to selectively control the active markers 32 to form different configurations of patterns as described in detail below. The positioning stripe may however be made of multiple rigid segments connected to each other according to another embodiment. The length of the segments must be small enough to reproduce any desired curvature.

As shown in FIG. 2, the position estimation module 14 comprises a camera sensor 16 configured to capture images in real-time of the configuration of patterns along the flexible positioning stripe 30, an Inertial Measurement Unit (IMU) 18 configured to detect changes in pitch, roll and yaw of the UAV 12 while flying, and a processing unit 19 for processing data sent by the camera sensor 16 and, when required, by the IMU 18. The processing unit 19 is configured to send instructions to the stripe controller 34 to selectively control the active markers 32 based on the data sent by the camera sensor 16 and optionally by the IMU 18. A control unit 20 which can be onboard the UAV 12 or offboard, i.e. a remote-control unit, is configured to control the velocity of the UAV 12.

In an embodiment, active markers 32 are evenly distributed over the entire length of a dynamically controlled positioning stripe 30. The set of markers 32 may preferably be in the form of LEDs with a fixed inter-LED distance. By having real-time control over the LEDs 32, a unique binary pattern may be generated. Unique binary patterns allow the position estimation module 14 to recognize specific patterns formed by different group of LEDs 32 in order to locate itself relative to the flexible positioning stripe 30.

Specific pattern may also send additional information to the position estimation module 14 through decoding of the patterns. For example, a unique binary pattern may be located near one end portion of the dynamically controlled positioning stripe 30 to send information to the UAV in order to switch from the positioning stripe to another type of navigation system such as a GPS.

The light of each LED on the dynamically controlled positioning stripe 30 may be controlled based on its position on the stripe. If for example the LEDs at index positions 100-102 and 105-106 are turned on as shown in FIG. 3, this will result in a binary pattern of: [1110011] starting at index 100, where 1 represents a LED that is turned on and 0 indicates that a LED is turned off.

The LEDs 32 may be attached for example to a PVC base-material which makes the positioning stripe 30 flexible and durable. The flexibility of the positioning stripe 30 enables to create curved drone trajectories and makes the handling during the setup very intuitive and easy. The positioning stripe 30 can also be attached to moving objects, walls, ceilings etc. The LEDs may advantageously be silicon coated, which makes the positioning stripe 30 waterproof for outdoor applications.

In an advantageous embodiment, the flexible positioning stripe 30 comprises near-field infrared LEDs emitting light at a wavelength ranging from 920 nm to 960 nm and preferably around 940 nm. Near-field infrared LEDs are advantageously not visible to the human eye while increasing the signal-to-noise ratio on the detection side. This makes the positioning stripe 30 particularly robust to outdoor applications.

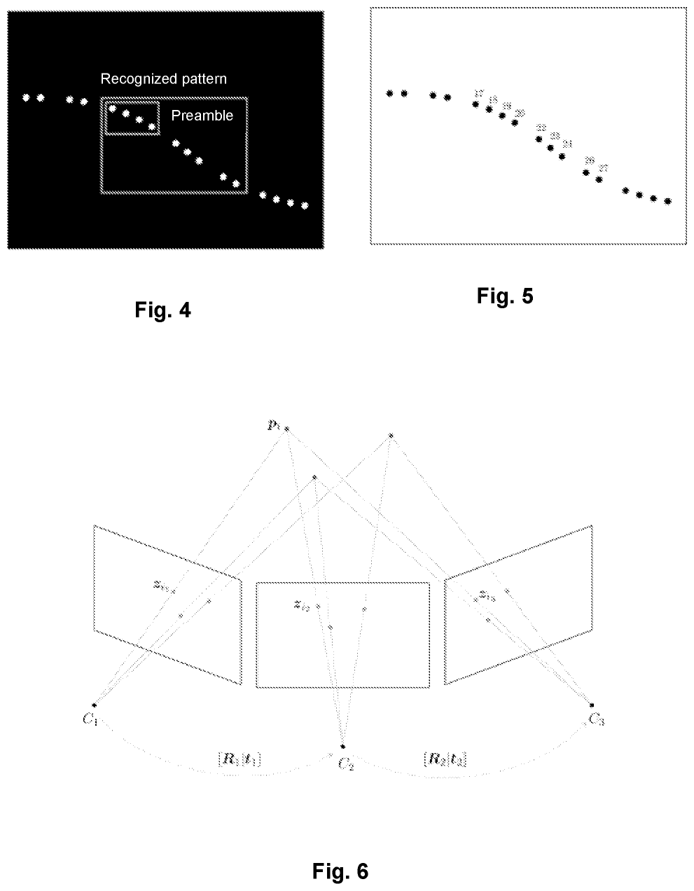

According to this embodiment, the camera sensor 16 is an infrared sensor. For the efficient detection of the Near-field infrared LEDs 32, a band-pass filter in the same spectral frequency range is used in order to increase the signal-to-noise ratio drastically, which results in an image of mostly dark background with blobs of higher intensity corresponding to the LEDs as shown in FIG. 4.

The camera comprises fisheye lens in order to increase the field of view for the detection of near-field infrared LEDs 32. This increases the possible dynamic range of the UAV 12 as well as the robustness of the position estimation itself. The camera sensor 16 may be of the type of a global shutter camera sensor to avoid distortions in the image when taken at high speed. The position estimation module 14 is configured to be powered directly by the UAV and includes a single-board computer

The (intensity weighted) centers of these bright blobs give the image coordinates of the corresponding LED 32. Each single LED is however not distinguishable from the others in the image plane. However, by detecting a group of markers, the underlying unique binary pattern the points belong to may be recognized. A single pattern entity may for example be recognized by a distinct preamble e.g. four subsequent LEDs 32 which are collectively turned on as shown in FIG. 4.

With the additional knowledge of the fixed inter-LEDs distance d (FIG. 3), a unique label may be assigned to each LED that is turned on corresponding to the LEDs index position on the positioning stripe 30 as shown in FIG. 5.

How the binary patterns are mapped onto the positioning stripe 30 is known according to the specific configuration of the positioning stripe. From recognizing a group of LEDs as a distinct pattern, the position of each single LED 32 relative to the positioning stripe 30 may be determined. Additionally, the ground truth position of each LED in terms of world coordinates [xᵢ^{W}, yᵢ^{w}, zᵢ^{w}] is computed with a preliminary mapping step. As a result, not only the position of each LED 32 along the positioning stripe 30 is known but also the actual spatial 3D information. From the set of LEDs positions, the shape of the positioning stripe 30 may be reconstructed with a spline interpolation.

With reference to FIG. 6, the mapping step creates a spatially consistent map of all the LEDs that are turned on. To achieve this, an estimation of the ground truth value of each ground truth position pᵢ=[xᵢ^{W}, yᵢ^{w}, zᵢ^{w}] of each LED along the positioning stripe 30 must be performed. This estimation may be performed through a variation of a structure from motion (SFM) algorithm. Additionally to the LEDs positions, an estimation of the ego-motion [Rᵢ|tᵢ] of the camera is performed with an extended Kalman filter. This adds a temporal dependency between the subsequent measurements [zᵢ₁, zᵢ₂, zᵢ₃] and camera poses [C₁, C₂, C₃].

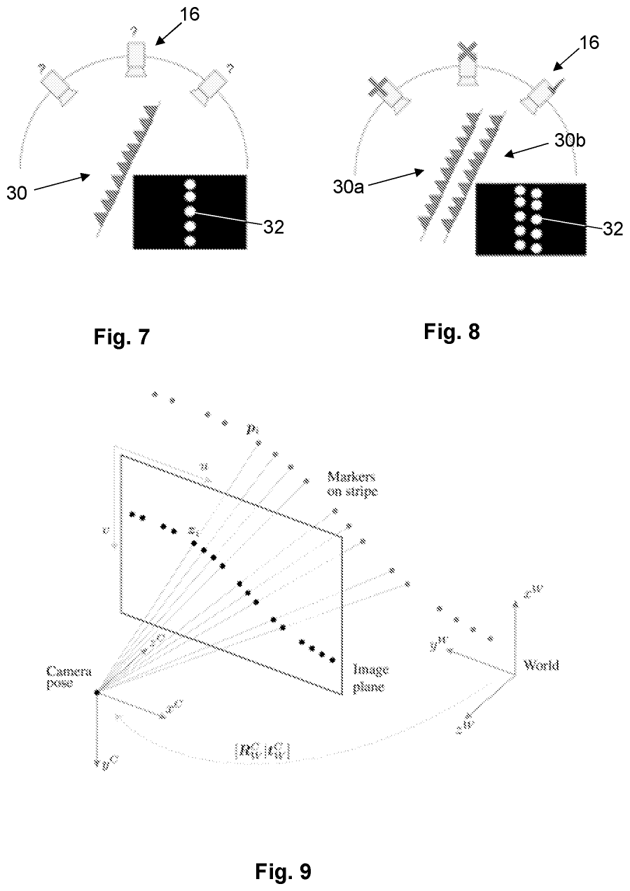

The variation of a structure from motion (SFM) algorithm makes the mapping more robust to the partially degenerate setting as shown in FIG. 7, whereby a portion of the positioning stripe 30 is straight with an arrangement of the LEDs 32 along a straight line, whereby the camera pose of the position estimation module 14 could by anywhere along an arc of 180°. In this particular case, the vision estimates captured by the camera sensor 16 may be fused with orientation measurements from the IMU 18 in order to retrieve the correct camera pose along the arc of 180°.

In order to recover the full camera pose, the 2D coordinates zᵢ of the detected LEDs in the image plane are matched to their corresponding LED indexes. Considering that the 3D world positions pᵢ of each LED index is known, the set of 2D-3D point or zᵢ−pᵢ correspondences must be solved through the Perspective-n-Point (PnP) problem. The goal of this step is to estimate the full six degree of freedom rigid body transformation from the positioning stripe 30 to the camera coordinate system.

Referring to FIG. 9, a Gauss-Newton algorithm is used to solve the overdetermined system of non-linear equations:

zᵢ=f(R_{W}^{C},t_{W}^{C},pᵢ,α)

where f is a non-linear measurement function, R_{W}^{C} and T_{W}^{C} are the unknown camera orientation and position respectively, and a is a set of camera calibration parameters that fit the fisheye camera model. Additionally, extended Kalman filter (EKF) is used to track the camera pose [R_{W}^{C}|T_{W}^{C}] over subsequent time steps

According to another embodiment, the UAV positioning system comprises two flexible positioning stripes 30a, 30b adapted to be arranged in parallel along a predefined path as shown in FIG. 8. In this case, the LEDs are guaranteed to be distributed in two dimensions and the PnP problem is well-posed (when limiting the solution space to z>0)

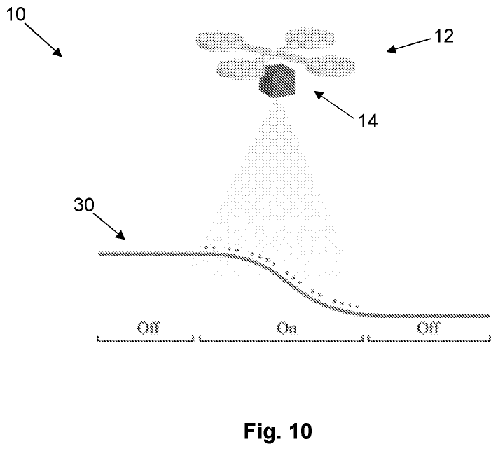

As shown in FIG. 10, each single LED 32 of the dynamically controlled positioning stripe 30 may be controlled individually and in real-time such that only the LEDs in the vicinity of the UAV are turned on based on the images captured by the camera sensor 16, thereby maintaining the power consumption of the positioning stripe 30 constant independently from the entire length of the stripe 30.

More particularly, as the position/velocity of the UAV and the positions of the LEDs are known, the LEDs which are the closest to the image centre, thereafter the “middle LED”, capture by the camera sensor 16 in the next time step may be determined. As each LED belongs to a group of LEDs, which group the middle LED belongs to may be determined, so-called “middle group” thereafter. One or more groups of LEDs trailing the middle group and one or more groups of LEDs ahead of the middle group may be selectively controlled.

For example, assuming that a group of LEDs comprises 10 LEDs, LED 437 is the “middle LED” in the next time step, so group 430-439 is the middle group and LEDs 400-469 are selectively turned on.

In an advantageous embodiment, the positioning stripe 30 is made of several removably coupled segments in order to provide a length-adjustable positioning stripe. The positioning stripe 30 is therefore scalable with no theoretical upper bound on the positioning stripe length. The total length of the positioning stripe may therefore be adapted according to the application.

The positioning stripe 30 serves also as a user interface for controlling the flight path of the drone. We can use the information of the 3D shape of the stripe for planning the desired drone trajectory. The xy-dimension of the stripe will be mapped one on one to the desired flight path, while the height (z-dimension) can be a function of x and y resulting in z=f(x, y), controlled manually z=f(u) or kept constant z=C.

The invention is not limited to the above described embodiments and may comprise alternative within the scope of the appended claims. For example, active markers in the form of LEDs may be replaced by passive markers (e.g. reflective markers). Although, passive markers would not offer the possibility to actively communicate with the UAV, they would still encode position information and therefore fulfil the main purpose of the positioning stripe, which is enabling self-localization of the UAV.

Without the ability to communicate through the positioning stripe another communication channel may be used, such as a radio channel, in order to control the UAV interactively along the positioning stripe. Alternatively, a flight itinerary could be pre-programmed. For example, a flight itinerary may be pre-programmed, whereby the UAV is instructed to fly to the end of the stripe, whereupon the UAV hovers for a given period of time and return back to the start. In this case, no communication channel to the UAV is needed as all computations to fulfil the flight itinerary can be done onboard.

### REFERENCE LIST

UAV positioning system 10
   Unmanned Aerial Vehicle (UAV) 12
      Position estimation module 14
         Camera 16
            Infrared sensor
            Global shutter camera sensor
            Fisheye lens
         Inertial Measurement Unit (IMU) 18
         Processing unit 19
   Remote control unit 20
      UAV velocity
      Camera framing
   Dynamically controlled positioning stripe 30
      Flexible stripe
         PVC
         Active markers 32
            LEDs
            Water-resistant coating
            Near-IR LEDs (˜940 nm)
      Stripe controller 34

1. An Unmanned Aerial Vehicle (UAV) positioning system, comprising:
at least one flexible positioning stripe comprising markers distributed along said positioning stripe to form different configurations of patterns, each of said configurations of patterns defining a reference position along the flexible positioning stripe, wherein said positioning stripe may be positioned along a predefined path,
an UAV
a position estimation module mounted on the UAV and comprising a camera configured to capture images in real-time of said configuration of patterns along the flexible positioning stripe, and
a control unit (20) configured to control the velocity of the UAV, wherein the position estimation module is configured to position the UAV above, below or next to the positioning stripe and along said positioning stripe based on successive configurations of patterns captured by the camera of the position estimation module, and wherein said at least one positioning stripe comprises a controller configured to dynamically control active markers based on the velocity of the UAV and the positions of said active markers along the position stripe in order to generate said successive configuration of patterns.

2. The UAV positioning system according to claim 1, wherein said at least one positioning stripe is made of several removably coupled segments in order to provide a length-adjustable positioning stripe.

3. The UAV positioning system according to claim 1, wherein the UAV or the position estimation module further comprises an Inertial Measurement Unit (IMU).

4. The UAV positioning system according to claim 1, wherein said active markers are arranged along said at least one positioning stripe at constant intervals.

5. The UAV positioning system according to claim 1, wherein said markers are Light Emitted Diodes (LEDs).

6. The UAV positioning system according to claim 5, wherein said LEDs are Near-IR LEDs, preferably in the spectral range from 920 nm to 960 nm, and most preferably around 940 nm.

7. The UAV positioning system according to any preceding claim, wherein said at least one positioning stripe is flexible preferably made of a PVC base-material.

8. The UAV positioning system according to any preceding claim, comprising two flexible positioning stripes adapted to be arranged in parallel along said predefined path.

9. A method of controlling an Unmanned Aerial Vehicle (UAV) along a predefined path using a dynamically controlled positioning stripe, a position estimation module mounted the UAV and a control unit configured to control the velocity of the UAV, wherein active markers are distributed along said positioning stripe, each marker being configured to be switched between an ON state and an OFF state to form different configurations of patterns, and wherein the position estimation module comprises a camera configured to captures images of portions of said positioning stripe, the method comprising the steps of:
computing the ground truth position pᵢ of the active markers in terms of world coordinates [xᵢ^{W}, yᵢ^{w}, zᵢ^{w}] in order to obtain a 3D representation of the markers;
capturing successive images of portions of said positioning stripe by the camera of the position estimation module while the UAV is moving along the positioning stripe to obtain successive image planes comprising each a distinctive pattern formed by a set of detected active markers,
measuring the 2D coordinates Zᵢ of each detected active marker in each image plane;
assigning a unique label to each detected marker in each image plane as a function of its position relative to the other detected markers in said image plane,
matching the 2D coordinates zᵢ of each image plane to said 3D representation of the markers in order to track the camera pose over subsequent interval of times, and
controlling the orientation of UAV as a function of the camera pose.

10. The method according to claim 9, wherein the UAV is positioned above the positioning stripe at a certain height which is either controlled manually by the remote-control unit, or constant over and along the entire length of the positioning stripe or as a function of the x-y position of successive portions of the positioning stripe.

11. The method according to claim 9, wherein the pose of the camera is fine-tuned based on information about yaw, pitch and roll angles sent to the UAV by the control unit.

12. The method according to claim 9, wherein the UAV or the position estimation module comprises an Inertial Measurement Unit (IMU), the pose of the camera being fine-tuned based on the measurements of the IMU.

13. The method according to claim 9, wherein only the active markers of said positioning stripe in the vicinity of the UAV are controlled based on said image planes.

14. The method according to claim 9, wherein the UAV or the position estimation module comprises a GPS sensor, and wherein a unique binary pattern is located near an end portion of the positioning stripe to send information to the UAV in order to switch from the positioning stripe to a GPS navigation system.

15. The method according to claim 9, wherein the step of computing the ground truth position pᵢ of the markers in terms of world coordinates [xᵢ^{W}, yᵢ^{w}, zᵢ^{w}] is achieved from a structure from motion (SFM) algorithm.

16. The method according to claim 9, wherein the ego-motion of the camera is estimated using a non-linear estimator, for example an extended Kalman filter, in order to add temporal dependency between successive images captured by the camera and camera poses (C₁, C₂, C₃).

17. A vehicle positioning kit, for example an Unmanned Aerial Vehicle (UAV), comprising:
at least one flexible positioning stripe comprising markers distributed along said positioning stripe to form different configurations of patterns, each of said configurations of patterns defining a reference position along the positioning stripe, wherein said positioning stripe may be positioned along a predefined path, and
a position estimation module adapted to be mounted on an vehicle and comprising a camera configured to capture images in real-time of said configuration of patterns along the flexible positioning stripe,
wherein the position estimation module is configured to position the vehicle above and along the flexible positioning stripe based on successive configurations of patterns captured by the camera of the position estimation module.

18. The vehicle positioning kit according to claim 17, further comprising a remote-control unit configured to control the velocity of the vehicle.

19. (canceled)
